(19) United States
(12) Patent Application Publication
(10) Pub. No.: US 2009/0034933 A1
(43) Pub. Date: Feb. 5, 2009

(54) Method and System for Remote Digital Editing Using Narrow Band Channels

(76) Inventor: Michael Dillon Rich, Fishers, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/988,779

(22) PCT Filed: Jul. 15, 2005
(86) PCT No.: PCT/US05/24884

§ 371 Date: Jan. 14, 2008

(51) Int. Cl. H04N 5/93

(52) U.S. Cl. 386/52

(57) ABSTRACT

A system and method for remotely editing content includes a first device for creating a first resolution version of an original content and a second device for creating a second higher resolution version of the original content. A remotely disposed editing station receives the first resolution version and performs editing operations on the first resolution version to generate editing parameters. An authoring system receives the editing parameters from the remotely disposed editing station and applies the editing parameters to the second higher resolution version to provide a production version of the original content as edited at the remote editing station.

### FIELD OF THE INVENTION

The present invention generally relates to editing systems for digital content and, more particularly, to systems and methods for editing video using a remotely located system accessed via narrow band communication channels.

### BACKGROUND OF THE INVENTION

With the prevalence of video cameras and video recording equipment, individuals and/or businesses have developed a need for recording videos or other digital information. With the recording of digital information also comes the need for editing the information. There are instances in which individuals wish to edit high-grade audio/video material (e.g., digital dailies commenting, DVD authoring, etc.). In many of these instances, the individual may not be co-located with the extensive equipment necessary to process high-grade digital audio and video, or the individual may not own such equipment.

In creating edited high-grade A/V material such as broadcast content or DVD-Video discs, it is typical for individuals to use capital-intensive workstations which include a device to digitally receive the content, store the content, manipulate the content, and create an edited version of the content such as a DVD-Video disc. The current reliance upon capital-intensive equipment makes this practice available only to those individuals with enough money to afford such a system. An example of this problem is observed in conventional services which have begun to be offered to consumers in which the service provider will take copies of the consumer's home video material (most often on analog media), and process the content into a digital media such as a DVD. These services have advantage in today's current practice, in that they allow a mechanism for consumers to digitize their A/V properties, without owning sophisticated equipment to do so. However, in order to sustain such services at a competitive pricing, service providers automate the practice by editing the content based upon generic/arbitrary methods. This automation alleviates the necessity for the service provider to pay the penalty of personally viewing all footage, for the purpose of making context-sensitive decisions in the editing process. This also means that the consumer foregoes the right to make context-sensitive decisions regarding the editing process which significantly add value to the final product. The resulting value of such arbitrarily-edited content is thus compromised.

### SUMMARY OF THE INVENTION

The present invention provides a set of automated devices which facilitate the editing of high-grade audio/visual materials using a data channel, which may include only a narrow-band data channel, and without owning capital-intensive equipment typically necessary to perform such edits.

Potential applications of the present invention include remote editing of digital video disk (DVD) videos in a service business model in which consumers edit their home-videos by remote processing. In such an example application, a consumer with a basic web-browser could communicate ‘edit’ information which would feed into the automated creation of, for example, a DVD-Video disc. Other applications may include use by the video production or film making industries. The subject matter may include films, digital dailies or any other content. This content may be edited remotely by crews on site without access to capital-intensive equipment on a film location.

Other applications are also contemplated such as video game development applications. Video game design teams can be extremely large, and often distributed. A designer working on one segment of the game (i.e., level design) might be remote from the servers/storage where the actual graphics and textures are actively being developed. By converting the working game environment into a “lower resolution” copy (in all respects—video, audio, artificial intelligence, etc.), remote edits may be accomplished without having to continually access the entire environment.

Embodiments of the present invention enable a device for remote creation of basic edits for high-grade A/V material using, for example, only a narrow-band data connection and standard equipment for interfacing to narrow-band data connections. The present invention may use any of several available technologies to achieve its function by consolidating those technologies in an appropriate fashion.

In one embodiment of the present invention a system and method for remotely editing content includes a first device for creating a first resolution version of an original content and a second device for creating a second higher resolution version of the original content. A remotely disposed editing station receives the first resolution version and performs editing operations on the first resolution version to generate editing parameters. An authoring system receives the editing parameters from the remotely disposed editing station and applies the editing parameters to the second higher resolution version to provide a production version of the original content as edited at the remote editing station.

In an alternate embodiment of the present invention a system for remotely editing content includes a server which receives original content from a user. The server includes a first encoder for creating a first resolution version of the original content, and a second encoder for creating a second higher resolution version of the original content. An authoring system may be provided at the server or at a different location and receives editing parameters designating editing operations performed on the first resolution version by a remotely disposed editing station and applies the editing parameters to the second higher resolution version to provide a production version of the original content as edited at the remote editing station.

In an alternate embodiment of the present invention a method for remotely editing digital content includes generating a low resolution version and a high resolution version of original content at a service provider wherein all frames of the low resolution version in sequential-presentation order correlate to the same frames in the high resolution version, sending the low resolution version to a remotely disposed editing station to permit a user to edit the low resolution version to create editing parameters and modifying the high resolution version at the service provider by applying the editing parameters generated for the low resolution version to the high resolution version.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an exemplary system for remotely editing electronic content in accordance with one embodiment of the present invention;

FIG. 2 depicts a flow diagram of a method for remotely editing electronic content in accordance with an illustrative embodiment of the present invention.

It should be understood that the drawings are for purposes of illustrating the concepts of the invention and are not the only possible configuration for the invention. To facilitate understanding, identical reference numerals have been used, where possible, to designate identical elements that are common to the figures.

### DETAILED DESCRIPTION OF THE INVENTION

Embodiments of the present invention include a set of automated devices which facilitate the creation of high-grade audio/visual edits of recordable materials using, for example, narrow-band data channels without the need for ownership of the capital-intensive equipment typically necessary to perform such edits. Although the present invention is described herein in terms of a video editing system, the present invention is much broader and may include any digital multimedia system which is capable of delivery of information over a network. In addition, the present invention is applicable to any editing system which may include transferring and editing data by telephone, set top boxes, computer, satellite links, cable network, other wireless or wired network types, etc.

It should be understood that the elements shown in the figures herein may be implemented in various forms of hardware, software or combinations thereof. Preferably, these elements are implemented in a combination of hardware and software on one or more appropriately programmed general-purpose devices, which may include a processor, memory and input/output interfaces.

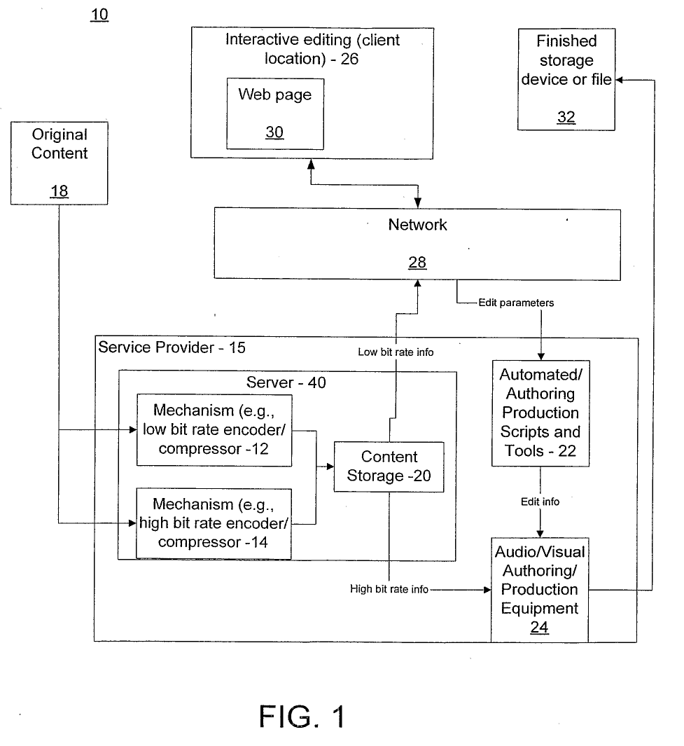

FIG. 1 depicts a high level block diagram of an exemplary system for remotely editing electronic content in accordance with one embodiment of the present invention. The remote editing system 10 of FIG. 1 illustratively comprises a source of original content 18, a service provider site 15, a client site 26 and a network 28. In the system 10 of FIG. 1, the service provider site 15 receives original content 18 from, for example, a user wishing to edit, for example, audio/visual information. The original content 18 from the user may be uploaded over the network 28, which may be, for example, the Internet, a cable network, a satellite network, a telecommunications network or any other network that supports electronic information transfer. Alternatively, the original content 18 may be sent to the service provider site 15 by mail or other physical transfer and loaded into a server 40 of the service provider 15. In an illustrative example, a user wishing to edit home movies stored on a DVD sends a copy of the DVD to the service provider 15. When the service provider 15 receives the DVD, the service provider 15 loads the content onto the server 40 of the service provider 15. The user can then access, for example, a web site of the service provider to access an account for manipulating the media content sent to the service provider 15 for editing. An editing session can then begin.

In an alternate embodiment of the present invention, a user can log into an account provided to them by the service provider 15 and can then upload content to be edited onto a web server of the service provider 15 and begin an editing process. In any case, original content to be edited is provided to the service provider 15. Original content 18 may include, for example, home video, pictures, audio recordings, raw preproduction film assets etc. or any combination therefore. The media of the original content 18 or a production version or product may include DVD's, compact disks (CDs), floppy disks, electronic files, film or any other data storage device.

The server 40 at the service provider site 15 illustratively comprises a first 12 and a second 14 receiving device for receiving remotely communicated original content to be edited. Receiving devices 12 and 14 can comprise any of several receiving devices which permit electronic (analog or digital) material to be digitally ingested for the purpose of subsequent processing, such as, encoders, compressors, multiplexers or other receiving devices which receive original content 18. In one embodiment of the present invention, receiving device 12 comprises a low bit rate encoder while receiving device 14 comprises a high bit rate encoder. In such an embodiment of the present invention, encoders 12 and 14 digitally encode/compress the material into a format which is appropriate for a final output of post-production. For example, encoders 12 and 14 can comprise MPEG-2 encoders, which when applied in a DVD-Video system will ingest material at Standard Definition resolution at a variable bit-rate which maintains a high quality level (e.g., 4-10 Mbps). While such data rates are appropriate for typical consumption models, it is these data rates which necessitate sophisticated equipment for the intensive task of editing intermediate materials.

As depicted in FIG. 1, in the server 40 at the service provider site 15, a parallel ingestion device (e.g., low bit rate encoder 12) is employed in addition to or instead of the primary device (high bit rate encoder 14). In the parallel receiving device 12, material is ingested into a digital format which is more suited to narrow-band data channels (such as the internet), consequently at lower resolution and lower bit-rate. It is preferable that this material be ingested in a manner that each sequential frame of presentation correlates exactly to the same frame of sequential presentation in the high bit-rate material. This is incorporated such that frame-accurate edits made to the low-bit-rate material will translate directly to frame-accurate edits made to the high-bit-rate material. For example, the high-bit-rate material could be Standard Definition MPEG-2 at 8 Mbps variable bit rate and the low-bit-rate material could be presentation-frame-synchronized QCIF resolution MPEG-4 at 128 Kbps.

The received and processed content from the receiving devices 12, 14, for example, the encoded content from the encoders 12 and 14, is stored in a content storage device 20, which may include any memory storage device. In accordance with the present invention, the low bit rate encoded media content to be edited stored in the server 40 of the service provider site 15 is communicated to a remote location for editing. For example, the low bit rate encoded content from the encoder 12 is transferred over the network 28 to a user interface or editing interface (not shown) at the client site 26 (i.e., remote editing site). The remote editing interface or user interface at the client site 26 may include a personal computer, a telephone (e.g., cell phone), a television set with an appropriate graphical user interface and editing tool (a keypad or keyboard and mouse, etc.) or any other interactive device or interface.

In one embodiment of the present invention, a web-page 30 viewable at the client site 26 is constructed for enabling a user to interactively edit the received content. The web page 30 provides an interactive interface, which enables the user to view the received narrow-band representation of the original content to be edited. Via this web interface, a user is able to perform frame-accurate edit operations including denoting start/stop boundaries of potential sequences, capturing specific frames to serve as “thumbnail” images for reference in menuing systems as well as other known editing operations. For example, the content may be indexed with scene or frame number or by time. The user may select portions of the content to delete or enhance select transitions between scenes, choose chapters and subchapters, alter the formatting, adjust focus zoom or any other modifications available or provided by the service provider. These operations/edits are performed on the low bit rate version of the content. As the user performs these operations, the user views the low-bit-rate representation of the material, which, as previously described, is easily able to be communicated via a narrow-band internet channel, broadband or other non-internet transmission.

It should be noted, however, since all frames of the low-bit-rate representation of the original content received at the user site 115 in sequential-presentation order correlate to the respective frames in the high-bit-rate representation of the original content, the references the user makes to a frame number or time index (for start/stop boundaries, thumbnails, etc.) of the low-bit-rate representation will directly correlate with the respective frame numbers (and/or times) within the high-bit-rate representation of the original content. In various embodiments of the present invention, it is at the service-provider's discretion as to whether the user is initially provided with key-frame points in the content (such as, e.g., scene-change-detection, automatic thumbnail selection) or if the user is left to arrive at such points independently.

Once a user has remotely edited the low-bit-rate content, the low-bit-rate content, which contains the editing information, is communicated to a remote location for content creation. In various embodiments of the present invention, the location for content creation is presumably a location where capital-intensive authoring equipment is located and can be the same location which houses the high-bit-rate content representation of the original content, and in this case the service provider site 15. More specifically, the system 10 of FIG. 1 illustratively comprises an automated authoring/production device/system 22 and audio/visual authoring/production equipment 24. Although in the system 10 of FIG. 1, the automated authoring/production device/system 22 and the audio/visual authoring/production equipment 24 are depicted as separate components, in alternate embodiments of the present invention, the functionality of the automated authoring/production device/system 22 may be included in the audio/visual authoring/production equipment 24 as software or hardware or a combination of both.

In the example described above, the user's edit points or parameters (as referenced, for example, by frame numbers in sequential presentation order or based on time indexing) are communicated to audio/visual authoring/production equipment 24 located at the service provider site 15. The audio/visual authoring/production equipment 24 receives the edit parameters communicated from the remote editing interface at the client site 26 and applies the edit parameters to the high bit rate production representation of the content stored on the content storage device 20. As previously described, the audio/visual authoring/production equipment 24 may include commercially available software and/or devices 22 for editing/authoring a digital file. For example, the authoring/production equipment 24 may include an automated scripting tool which can create DVD-Video menuing systems, chapter breaks, and other DVD-Video features, given any arbitrary MPEG-2 material.

The now edited high bit rate production representation of the original content may then be recorded on a digital media device such as a DVD, CD, magnetic disk or any other storage device able to be produced using audio/visual authoring/production equipment 24. Alternatively, the now edited high bit rate production representation of the original content may be communicated to the client site 26 directly for download by the user. In one embodiment of the present invention, the content is recorded on a DVD, CD or other storage device and can create a disc image from MPEG-2 material.

The present invention advantageously provides a system and method in which the edit points for MPEG-2 or other format material are actually now determined by the frame-references corresponding to a remote user's edits. Existing automation script technologies may be extended to accept as input parameters these user inputs as gathered from the web-page interface.

In alternate embodiments of the present invention, the audio/visual authoring/production equipment 24 of the system 10 of FIG. 1 can be configured as a mastering component which is able to produce the edited content as a production product 32 (e.g., finished storage device including edited high bit rate production content) as intended by the user's editing choices via, for example, the web-page. Such a production product may include a DVD-Video disc or, alternatively, a broadcast presentation or some other means of digital media.

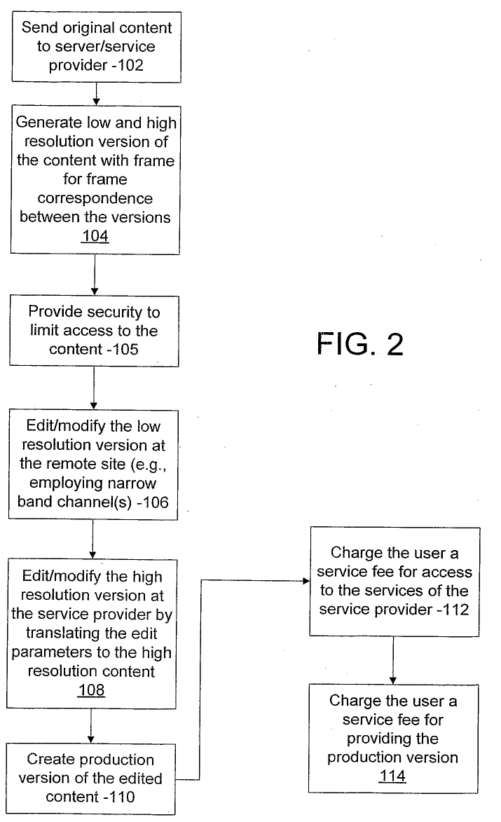

FIG. 2 depicts a flow diagram of a method for remotely editing electronic content in accordance with an illustrative embodiment of the present invention. The method 200 of FIG. 2 begins in block 102 where original content (home movies, tape recordings etc.) is sent to a service provider either manually (e.g., by mail, drop off at a designated location on a portable storage media) or sent electronically (e.g., via email, file transfer, etc.). The service provider generates a low resolution version and a high resolution version of original content wherein all frames of the low resolution version in sequential-presentation order correlate to the respective frames in the high resolution version in block 104.

In block 105, security measures are provided. Since the original content may be of a personal or confidential nature appropriate steps may be needed to ensure that the content is not accessible by others. This may include a number of different methods for securing the information. For example, a secure account number and user name may be employed to grant access to a server of the service provider, or once the original content is sent to the service provide a key may be sent to the user at the user designated address or location. The key would then by used to gain access to the service provider's system. Other systems and method may also be employed.

In block 106, the low resolution version is sent to a remotely disposed editing station to permit a user to edit the low resolution version to create editing parameters. The remote station may be at a user's residence, a cyber café, a kiosk or any other designated location. The editing parameters may include frame numbers or other indicia for deleted or modified frames or scenes from the low resolution version of original content. The editing parameters and other communications with the service provider are preferably maintained over a narrow band channel or channels (e.g., over the internet using telephone or cable networks).

In block 108, the high resolution version at the service provider is modified by applying the editing parameters generated for the low resolution version to the high resolution version. The low resolution edits are transferred or translated to the high resolution version. The edits include sequential-presentation order correlation between the same frames of the low and high resolution versions. In block 110, a portable storage media device may be created having the modified high resolution version of the original content (or the production version). The production version may be sent electronically to the user via email or file transfer as the case may be.

In block 112, the user may be charged a service fee for services related to editing the original content as provided by the service provider. This may be based on edit or access time or may include a flat fee. In block 114, a service fee may be charged for providing the portable storage media device or downloadable production version of the content. This may be based on edit or access time, amount of memory recorded or may include a flat fee.

The method may be implemented or provided on a program storage device readable by machine, tangibly embodying a program of instructions executable by the machine to perform the method steps.

Having described preferred embodiments for systems and methods for channel surfing which permits recording of preferred channels (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof. As such, the appropriate scope of the invention is to be determined according to the claims, which follow.

1. A system for remotely editing content, comprising:
a first device for creating a first resolution version of an original content;
a second device for creating a second higher resolution version of the original content;
a remotely disposed editing station which receives the first resolution version and performs editing operations on the first resolution version to generate editing parameters; and
an authoring system which receives the editing parameters from the remotely disposed editing station and applies the editing parameters to the second higher resolution version to provide a production version of the original content as edited at the remote editing station;
wherein all frames of the first resolution version in sequential presentation order correlate to the same frames in the second higher resolution version.

2. The system as recited in clam 1, wherein the first and second devices and the authoring system are located at a service provider location and the editing station is located at a user location and communications between the service provider and the user location are transmitted over a network.

3. The system as recited in claim 2, wherein the network includes one of the Internet, a cable network, or a telephone network.

4. The system as recited in claim 2, wherein the communication are carried out over a narrow communications channel.

5. The system as recited in claim 2, wherein the original content is delivered on a portable media device to the service provider.

6. The system as recited in claim 1, wherein the first and second devices include encoders.

7. (canceled)

8. The system as recited in claim 1, further comprising authoring production equipment for storing the production version to a media device.

9. The system as recited in claim 1, wherein the original content is uploaded over a network by a user.

10. A system for remotely editing content, comprising:
a server which receives original content from a user, the server including:
a first encoder for creating a first resolution version of the original content;
a second encoder for creating a second higher resolution version of the original content; and
an authoring system which receives editing parameters designating editing operations performed on the first resolution version by a remotely disposed editing station and applies the editing parameters to the second higher resolution version to provide a production version of the original content as edited at the remote editing station;
wherein all frames of the first resolution version in sequential presentation order correlate to the respective frames in the second higher resolution version.

11. The system as recited in claim 10, wherein communications between the server and the user location are transmitted over a narrow band channel.

12. The system as recited in claim 11, wherein the narrow band channel is carried over one of the Internet, a cable network, or a telephone network.

13. The system as recited in claim 10, wherein the original content is delivered on a portable media device to the server.

14. (canceled)

15. The system as recited in claim 10, further comprising authoring production equipment for storing the production version to a media device.

16. The system as recited in claim 10, wherein the original content is uploaded over a network by a user.

17. A method for remotely editing digital content, comprising the steps of:
generating a low resolution version and a high resolution version of original content wherein all frames of the low resolution version in sequential presentation order correlate to the respective frames in the high resolution version;
sending the low resolution version to a remotely disposed editing station to permit the editing of the low resolution version to create editing parameters; and
modifying the high resolution version by applying the editing parameters generated for the low resolution version to the high resolution version.

18. The method as recited in claim 17, further comprising the step of charging a service fee for providing services related to editing the original content.

19. The method as recited in claim 17, further comprising the step of creating a portable storage media device having the modified high resolution version of the original content.

20. The method as recited in claim 19, further comprising the step of charging a service fee for providing the portable storage media device.

21. A program storage device readable by machine, tangibly embodying a program of instructions executable by the machine to perform method steps as recited in claim 17.
